(19) United States
(12) Patent Application Publication
(10) Pub. No.: US 2025/0165673 A1
(43) Pub. Date: May 22, 2025

(54) DIGITAL TWINNING METHOD FOR MONITORING OPERATION STATE OF TOWER OF WIND TURBINE GENERATOR SYSTEM ONLINE

(71) Applicant: ZHEJIANG UNIVERSITY OF TECHNOLOGY, Zhejiang (CN)

(72) Inventors: Xiaohang JIN, Zhejiang (CN); Haoxuan YANG, Zhejiang (CN)

(73) Assignee: ZHEJIANG UNIVERSITY OF TECHNOLOGY, Zhejiang (CN)

(21) Appl. No.: 18/736,512

(22) Filed: Jun. 6, 2024

(30) Foreign Application Priority Data
Nov. 22, 2023 (CN) 202311565128.8

(51) Int. Cl. G06F 30/23; G06F 113/06; G06F 119/02

(52) U.S. Cl. CPC G06F 30/23; G06F 2113/06; G06F 2119/02

(57) ABSTRACT

Disclosed is a digital twinning method for monitoring an operation state of a tower of a wind turbine generator system online. The method includes: 1) constructing a simplified model of the tower of the wind turbine generator system, and discretizing the simplified model according to a finite element method to obtain a finite element model; 2) reducing an order of the finite element model of the tower according to proper orthogonal decomposition, analyzing precision of a reduced-order model under different orders, and selecting the reduced-order model having a smallest reduced order as a final reduced-order model on the premise that the precision satisfies actual engineering requirements; and 3) programming upper computer software in a computer, deploying the reduced-order model to the upper computer software, further building a physical entity of the tower, and monitoring a stress and a strain of the physical entity online through the reduced-order model.

### CROSS-REFERENCE TO RELATED APPLICATION

This application claims the priority benefit of China application serial no. 202311565128.8, filed on Nov. 22, 2023. The entirety of the above-mentioned patent application is hereby incorporated by reference herein and made a part of this specification.

### TECHNICAL FIELD

The present disclosure relates to the technical field of state evaluation of a wind turbine generator system, and in particular to a digital twinning method for monitoring an operation state of a tower of a wind turbine generator system online.

### BACKGROUND

A tower, a key support component of a wind turbine generator system, has a health state affecting operation safety of the entire wind turbine generator system. With a complex alternating load and an influence of a harsh environment, the tower of the wind turbine generator system is prone to fail, resulting in serious accidents of shutdown and even collapse of the wind turbine generator system. Consequently, it is necessary to monitor a state of the tower of the wind turbine generator system online.

Digital twinning constructs a digital twinning model by digitally mapping a physical entity of an apparatus to a digital space at a full spatial scale and throughout a full life cycle, and perceives an operation condition of the apparatus and optimizes the apparatus for control by means of virtual and real interactive feedback between the digital twinning model and the physical entity, thereby maximizing effectiveness of the apparatus. As a result, the digital twinning has a broad application prospect in online monitoring of an operation state of the apparatus. However, the digital twinning of a complex physical entity involves solving a physical field differential equation of an apparatus entity, and has high requirements for a speed of solving the differential equation. A traditional numerical method (such as a finite element method, a finite volume method and a finite difference method) has high computational cost owning to the excessively high number of degrees of freedom in a discretized equation when solving the physical field differential equation, making it difficult to directly use the traditional numerical method to construct the digital twinning model of the tower of the wind turbine generator system.

A model reduction method effectively reduces computational cost by obtaining a low-dimensional reduced order model from a high-dimensional finite element model by means of methods of numerical fitting, physical simplification, mathematical projection, etc. Physical quantities (such as stress and strain) of the tower can be calculated and analyzed in real time by constructing the digital twinning model of the tower according to the model reduction method, thereby perceiving the operation state of the tower online, which is beneficial to ensurance in safe and efficient operation of the wind turbine generator system.

### SUMMARY

An objective of the present disclosure is to provide a digital twinning method for monitoring an operation state of a tower of a wind turbine generator system online, and an overall implementation process, and a technical implementation is shown in FIG. 1.

The technical solution of the present disclosure is as follows:
a digital twinning method for monitoring an operation state of a tower of a wind turbine generator system online includes:
step 1, obtaining a simplified physical model of the tower of the wind turbine generator system according to geometrical characteristics of the tower of the wind turbine generator system, and analyzing an actual stress condition of the tower to construct a finite element model of the tower;
step 2, carrying out order reduction analysis on the finite element model constructed in step 1 according to proper orthogonal decomposition (POD), comparing precision of a reduced-order model under different orders, and determining a final reduced order, where the final reduced order satisfies engineering requirements of the reduced model under the order, and the present disclosure requires that a relative error between a predicted value of the final reduced-order model and a calculated value of the finite element model is less than 1%; and
step 3, designing and constructing upper computer software in a computer, and deploying the reduced-order model of the tower to the upper computer software; building a physical entity of the tower, installing a strain sensor and an inclination sensor, reading sensor data and uploading the data to an upper computer through a single chip microcomputer, so as to convert the data into a displacement boundary condition, and then inputting the displacement boundary condition into the reduced-order model for calculation; and determining accuracy of the digital twinning method for monitoring the operation state of the tower by calculating an error between a measured strain value of the strain sensor and a calculated strain value of the reduced-order model in the upper computer.

Further, step 1 includes: simplifying a flange connection structure between the tower of the wind turbine generator system, and simplifying the tower into a beam structure, so as to construct the simplified physical model of the tower. A schematic diagram of bending deformation of the simplified model of the tower is shown in FIG. 2. In the figure, a point of intersection of an axis of the tower before bending deformation and a lower end surface of the tower is an origin O of a coordinate system XYZ; and n₀ and n₁ are normal vectors of an end surface at a top end of the tower before bending deformation and after bending deformation respectively, and an included angle between the two vectors is an inclination angle θ of the end surface at the top end of the tower. An expression of deflection w and the inclination angle θ of the end surface at the top end of the tower is as follows:

$$\{ \begin{matrix}w = \frac{F}{6 EI} {L}^{3} - \frac{FL}{2 EI} {L}^{2} \\ θ = \frac{F}{2 EI} {L}^{2} - \frac{FL}{EI} L\end{matrix} w = \frac{2}{3} L θ \qquad ( 1 )$$

where F is a concentrated load applied at the top end of the tower, and has a unit of N; E is an elastic modulus of a tower material, and has a unit of Pa; I is cross sectional moment of inertia of the tower, and has a unit of m⁴; and L is a length of the tower, and L is set as 1 m in the example of the present disclosure.

The deflection w and an azimuth φ need to be determined to describe the bending deformation of the tower in a three-dimensional space, and the azimuth is defined in FIG. 2, and is configured to express a bending orientation of the tower. Therefore, the displacement boundary condition of the finite element model of the tower is determined by the two parameters of w and φ, w and φ are defined in FIG. 2, and according to a principle of linear superposition and decomposition of force, the displacement boundary condition of the tower is determined to obtain:

$${q}_{b} = {w}_{x} {q}_{bx} + {w}_{y} {q}_{by} = ( w cos φ ) {q}_{bx} + ( w sin φ ) {q}_{by} \qquad ( 2 )$$

where q_{bx}=[1, 0, 1, 0, . . . , 1, 0]^{T}, q_{by}=[0, 1, 0, 1, . . . , 0, 1]^{T}, a vector length is determined by a specific displacement boundary condition, and the vector length is 24 in the example; q_{b} is a joint displacement vector determined by the displacement boundary condition of the tower, i.e. a joint displacement vector corresponding to a joint having a displacement constraint of the tower; wₓ is a component of total deflection in a direction X; and w_{y} is a component of the total deflection in a direction Y.

The deflection w at the top end of the tower is converted into the displacement boundary condition, the finite element model of the tower is constructed, and an equilibrium equation of the finite element model of the tower under the displacement boundary condition is shown in formula (3):

$$[ \begin{matrix}{K}_{aa} & {K}_{ab} \\ {K}_{ba} & {K}_{bb}\end{matrix} ] [ \begin{matrix}{q}_{a} \\ {q}_{b}\end{matrix} ] = [ \begin{matrix}{g}_{a} \\ {g}_{b}\end{matrix} ] + [ \begin{matrix}0 \\ {R}_{r}\end{matrix} ] \qquad ( 3 )$$

where Kₐₐ is a stiffness matrix corresponding to a joint node having no displacement constraint of the tower; K_{ab} and K_{ba} are coupling matrices between the joint having the displacement constraint and the node having no displacement constraint of the tower; K_{bb} is a stiffness matrix corresponding to the joint having the displacement constraint of the tower; qₐ is a joint displacement vector of the joint having no displacement constraint of the tower; gₐ and g_{b} are joint gravity load vectors corresponding to the joint having no displacement constraint and the joint having the displacement constraint of the tower respectively; and Rᵣ is a joint support reaction force vector corresponding to the joint having the displacement constraint of the tower.

Further, step 2 includes: constructing the reduced-order model of a displacement field of the tower by combining the POD with a finite element method as follows:
solving the finite element model of step 1 to obtain a displacement solution set of a joint, and selecting m samples from the set to form a matrix X=[q₁, q₂, . . . , qₘ], where qᵢ=[u₁, u₂, . . . , u_{z}]^{T} is a displacement solution of the joint, and z is the number of degrees of freedom of the finite element model; {ζ₁, ζ₂, . . . , ζₙ} is set as a group of n orthonormal bases of X, and is written as a matrix form denoted as Φ; and for the finite element model of the tower, a joint displacement value qₜ at any moment is represented by {ζ₁, ζ₂, . . . , ζₙ}:

$${q}_{t} = {\sum }_{i = 1}^{n} {b}_{ti} {ζ}_{i} \qquad ( 4 )$$

where bₜᵢ=ζᵢ^{T}qₜ;
selecting first k orthonormal basis vectors from {ζ₁, ζ₂, . . . , ζₙ} to represent qₜ:

$${q}_{t ( k )} = {\sum }_{i = 1}^{k} {b}_{ti} {ζ}_{i} = {Φ}_{k} {b}_{t ( k )} \qquad ( 5 )$$

where Φₖ={ζ₁, ζ₂, . . . , ζₖ}; and bₜ₍ₖ₎=[bₜ₁, bₜ₁, . . . , bₜₖ]^{T};
establishing an error function as follows:

$${ε}^{2} = {\sum }_{t = 1}^{n} {‖ {q}_{t} - {q}_{t ( k )} ‖}_{2}^{2} = {\sum }_{j = k + 1}^{n} {ζ}_{j}^{T} {XX}^{T} {ζ}_{j} \qquad ( 6 )$$

in order to obtain an optimal solution of the error function under a constraint condition {ζ₁, ζ₂, . . . , ζₙ} of the orthogonal bases, introducing Lagrange factors uᵢⱼ (i, j=k+1, k+2, . . . , n) to construct a Lagrange function, so as to find the orthonormal bases corresponding to the optimal solution:

$$L = {\sum }_{j = k + 1}^{n} {ζ}_{j}^{T} {XX}^{T} {ζ}_{j} - {\sum }_{i = k + 1}^{n} {\sum }_{j = k + 1}^{n} [ {u}_{ij} ( {ζ}_{i}^{T} {ζ}_{j} - {δ}_{ij} ) ] \qquad ( 7 )$$

where δᵢⱼ, is a Kronecker function;
solving a partial derivative of ζⱼ from two ends of formula (7) to obtain:

$$\frac{\partial L}{\partial {ζ}_{j}} = 2 ( {XX}^{T} {ζ}_{j} - {\sum }_{i = k + 1}^{n} {u}_{ij} {ζ}_{j} ) = 2 {XX}^{T} {ζ}_{j} - 2 {Φ}_{n - k} {u}_{j} \qquad ( 8 )$$

where Φₙ₋ₖ=[ζₖ₊₁, ζₖ₊₂, . . . , ζₙ]^{T}, and uⱼ=[u_{k+1,j}, u_{k+2,j}, . . . , u_{n,j}]^{T}; writing the formula into a matrix form to obtain the following formula:

$$\frac{\partial L}{\partial {Φ}_{n - k}} = 2 ( {XX}^{T} {Φ}_{n - k} - {Φ}_{n - k} {U}_{n - k} ) \qquad ( 9 )$$

where Uₙ₋ₖ=[uₖ₊₁, uₖ₊₂, . . . , uₙ]^{T}; in order to solve the optimal solution, making equation (9) equal to 0, and multiplying the equation left by Φₙ₋ₖ^{T}, where internal vectors of a matrix Φₙ are orthonormal, and therefore Uₙ₋ₖ=Φₙ₋ₖ^{T}XX^{T}Φₙ₋ₖ=(X^{T}Φₙ₋ₖ)^{T}X^{T}Φₙ₋ₖ is obtained, and it is easy to know that Uₙ₋ₖ is a positive semi-definite matrix, and therefore an orthogonal matrix P exists to diagonalize Uₙ₋ₖ, so as to obtain P^{T}Φₙ₋ₖ^{T}XX^{T}Φₙ₋ₖP=P^{T}Uₙ₋ₖP=Λ; and multiply two ends of the formula left by Φₙ₋ₖP to obtain the following formula:

$${Φ}_{n - k} {PP}^{T} {Φ}_{n - k}^{T} {XX}^{T} {Φ}_{n - k} P = {Φ}_{n - k} {PP}^{T} {U}_{n - k} P = {Φ}_{n - k} P Λ \qquad ( 10 )$$

$$⇓$$

$${XX}^{T} {Φ}_{n - k} P = {Φ}_{n - k} {U}_{n - k} P = {Φ}_{n - k} P Λ$$

where Λ is a diagonal matrix of Uₙ₋ₖ; arranging diagonal elements of Λ in descending order, where it is seen from formula (10) that an i-th diagonal element of Λ is an eigenvalue λᵢ of XX^{T}, and an i-th column of a matrix Φₙ₋ₖP is an eigenvector of XX^{T} corresponding to λᵢ; and considering that the orthogonal matrix is norm-preserving under a Frobenius norm ∥•∥_{F}², formula (6) is rewritten as:

$${ε}^{2} = {‖ {X}^{T} {Φ}_{n - k} ‖}_{F}^{2} = {‖ {X}^{T} {Φ}_{n - k} P ‖}_{F}^{2} = trace \{ {( {X}^{T} {Φ}_{n - k} P )}^{T} {X}^{T} {Φ}_{n - k} P \} = trace \{ Λ \} \qquad ( 11 )$$

forming a transformation matrix Φₙ from left singular value vectors corresponding to first n singular values of X, where Φₙ is an optimal solution of the error function under the condition that the constraint condition {ζ₁, ζ₂, . . . , ζₙ} is the orthonormal bases, and a minimum value of the error function is the sum of last n−k eigenvalues of the matrix XX^{T}; defining the following formula:

$$I ( k ) = {\sum }_{i = 1}^{k} {λ}_{i} / {\sum }_{i = 1}^{n} {λ}_{i} \qquad ( 12 )$$

where λᵢ is an eigenvalue of XX^{T} arranged in descending order; and retaining, by a k-dimensional base vector, d % of characteristic information of an original sample under the condition of I(k)≥d %; and constructing the reduced-order model under different orders, and calculating precision of the reduced-order model under different reduced orders separately to determine the appropriate reduced order and obtain the reduced-order model, where the finally determined reduced order satisfies actual engineering requirements of the reduced-order model under the order.

Further, in step 3, the physical entity of the tower is built to construct the simplified model of reduction of the tower, the strain sensor and the inclination sensor are installed on the physical entity of the tower; a single chip microcomputer program is written to read data measured by the sensor and upload the data to the computer; the upper computer software is designed and constructed on the computer, and the reduced-order model is deployed to the upper computer software; and the upper computer reads the sensor data uploaded by the single chip microcomputer, converts the data into the displacement boundary condition, and inputs the displacement boundary condition into the reduced-order model to achieve rapid calculation, so as to obtain calculated strain and stress values of the current physical entity of the tower and a displacement solution of a joint; after calculation of the reduced-order model is completed, a calculation result is processed in the upper computer, that is, deformation of the physical entity of the tower is rapidly quantified on the basis of the displacement solution of the joint and displayed in the upper computer; an error between a strain calculation result of the reduced-order model and an actual strain of the physical entity is obtained by means of a strain value calculated by the reduced-order model and a strain value measured by a sensor; and stress nephogram is visualized by combining the displacement solution of the joint with the calculated stress value to intuitively and clearly express stress distribution of the physical entity of the tower. Virtual and real interactive analysis between the physical entity of the tower and the reduced-order model shows that the digital twinning method for monitoring an operation state of a tower of a wind turbine generator system online based on the POD can effectively calculate physical quantities (such as stress, strain and displacement) of the physical entity in real time and achieve high precision, thereby monitoring the operation state of the tower online.

### BRIEF DESCRIPTION OF THE DRAWINGS

FIG. 1 is a road map of a technical implementation of the present disclosure.

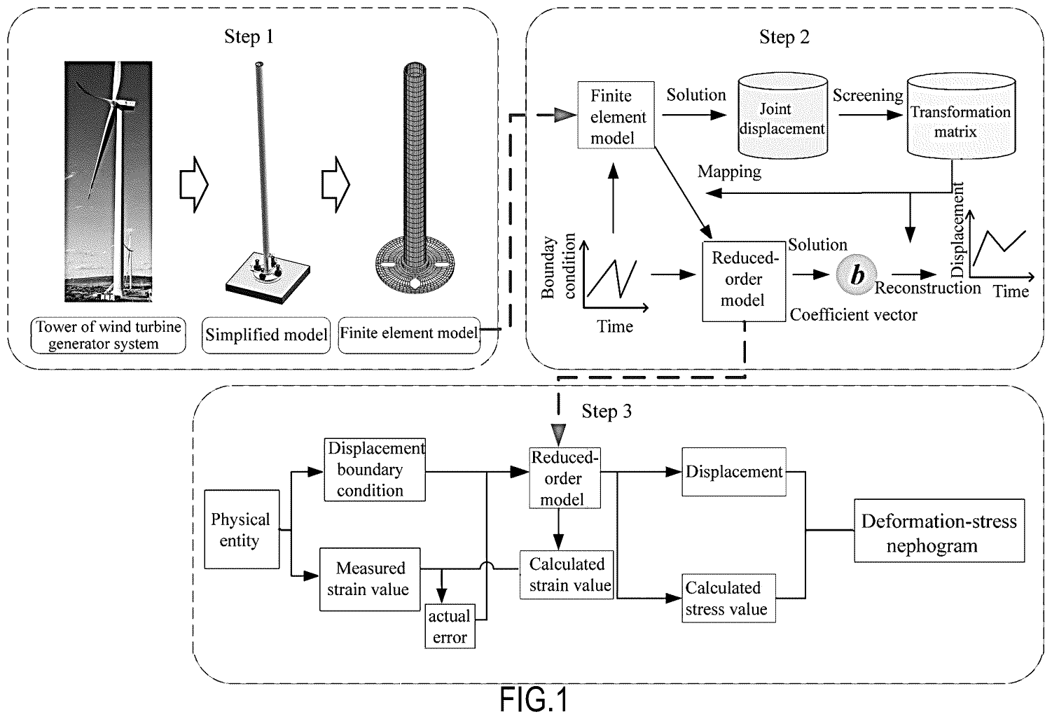

FIG. 2 is a schematic diagram of deformation of a tower of a wind turbine generator system.

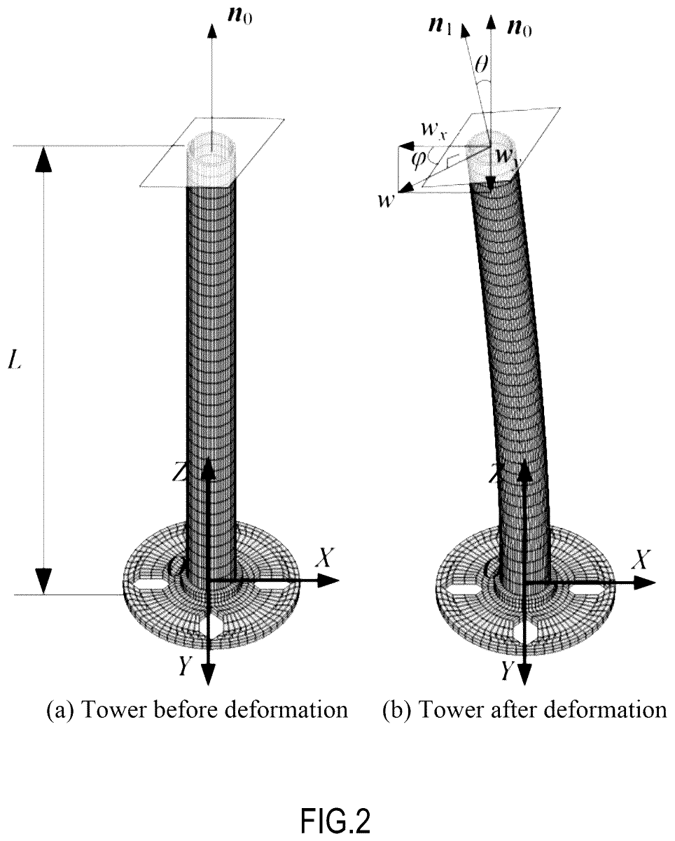

FIG. 3 is a graph of logarithmic distribution of singular values.

FIG. 4 is a graph of characteristic information of each order of transformation matrix without retaining original samples.

FIG. 5 is a diagram of relative error logarithmic values of a 5-order reduced-order model at each degree of freedom.

FIG. 6 is a schematic diagram of a physical entity of a simplified tower, a diagram of the physical entity, and a diagram of a digital twinning model.

FIG. 7 is an interface diagram of upper computer software.

FIG. 8 is a diagram of calculation of online monitoring of a maximum von-mises stress of a simplified tower.

FIG. 9 is a diagram of calculation of online monitoring of a strain of a simplified tower.

### DETAILED DESCRIPTIONS OF THE EMBODIMENTS

The present disclosure will be further described below in combination with the accompanying drawings of the description and the examples.

A digital twinning method for monitoring an operation state of a tower of a wind turbine generator system online specifically includes:

Step 1: a simplified physical model of the tower of the wind turbine generator system is established, the tower is approximated to a slender beam having a flange structure at one end, a beam cross section is in a shape of a circular ring, and a material is polyvinyl chloride (PVC); and the simplified model is divided into meshes through a 3D8 joint entity structure unit to obtain a mesh model including 7080 joints and 3780 units.

In order to calculate a joint displacement vector qₐ of a joint having no displacement constraint of the tower, formula (3) is deformed to obtain the following formula:

$$\{ \begin{matrix}{K}_{aa} {q}_{a} = {g}_{a} - {K}_{ab} {q}_{b} \\ {K}_{bb} {q}_{b} = {g}_{b} + {R}_{r} - {K}_{ba} {q}_{a}\end{matrix} ⇒ {K}_{aa} {q}_{a} = {g}_{a} - {K}_{ab} {q}_{b} \qquad ( 13 )$$

Deflection w at a top end of the tower and a bending azimuth φ of the tower are sampled according to a Latin hypercube sampling method to determine a sampling range of the deflection as [0, 0.15], a sampling range of an azimuth as [0, 2π), and the number of sampling points as 20. Results are shown in Table 1:

TABLE 1
Sampling results obtained according to Latin
hypercube sampling method for deflection at
top end of tower and bending azimuth of tower

| Sampling point sequence | | |
|---|---|---|
| number | Deflection w/m | Azimuth φ/rad |
| 1 | 0.123 | 0.317 |
| 2 | 0.072 | 0.888 |
| 3 | 0.054 | 1.489 |
| 4 | 0.081 | 2.074 |
| 5 | 0.024 | 4.060 |
| 6 | 0.036 | 3.554 |
| 7 | 0.139 | 2.701 |
| 8 | 0.145 | 2.832 |
| 9 | 0.091 | 5.842 |
| 10 | 0.021 | 5.145 |
| 11 | 0.045 | 4.349 |
| 12 | 0.061 | 1.765 |
| 13 | 0.131 | 2.462 |
| 14 | 0.004 | 0.075 |
| 15 | 0.011 | 6.009 |
| 16 | 0.042 | 5.544 |
| 17 | 0.108 | 4.497 |
| 18 | 0.116 | 3.363 |
| 19 | 0.098 | 1.089 |
| 20 | 0.084 | 4.765 |

Data in Table 1 is substituted into formula (2) to obtain a displacement boundary condition, and then substituted into formula (13) for calculation to obtain a displacement solution set of joints, and the displacement solution set of a joint is used in step 2 to construct a reduced-order model. Physical quantities finally monitored online in the present disclosure are a stress and a strain, and the stress and the strain at any unit joint may be calculated according to a displacement solution of the joint with reference to formula (14):

$$σ ( {x}_{0} , {y}_{0} , {z}_{0} ) = [ \begin{matrix}{σ}_{xx} \\ {σ}_{yy} \\ {σ}_{zz} \\ {σ}_{xy} \\ {σ}_{yz} \\ {σ}_{zx}\end{matrix} ] = D ε ( {x}_{0} , {y}_{0} , {z}_{0} ) = D [ \begin{matrix}{ε}_{xx} \\ {ε}_{yy} \\ {ε}_{zz} \\ {ε}_{xy} \\ {ε}_{yz} \\ {ε}_{zx}\end{matrix} ] = D [ \partial ] N ( {x}_{0} , {y}_{0} , {z}_{0} ) q \qquad ( 14 )$$

σ(x₀, y₀, z₀) is the stress at the unit joint at a coordinate (x₀, y₀, z₀); D is a material elastic coefficient matrix; ε(x₀, y₀, z₀) is the strain at the unit joint at the coordinate (x₀, y₀, z₀); [∂] is an operator matrix of a geometric equation; N(x₀, y₀, z₀) is a shape function matrix at the coordinate (x₀, y₀, z₀); and σₓₓ, σ_{yy}, σ_{zz}, σ_{xy}, σ_{yz} and σ_{zx} are stress components at the unit joint separately, and εₓₓ, ε_{yy}, ε_{zz}, ε_{xy}, ε_{yz}, and ε_{zx} are strain components at the unit joint separately.

Step 2: according to Table 1, the displacement boundary condition is determined, a finite element model is solved, the calculated displacement solution of the joint is sorted corresponding to sampling point sequence numbers to form a matrix V=[v₁, v₁, . . . , v₂₀], and the matrix V is decomposed through singular values to obtain a singular value matrix Σ and a left singular value vector matrix W.

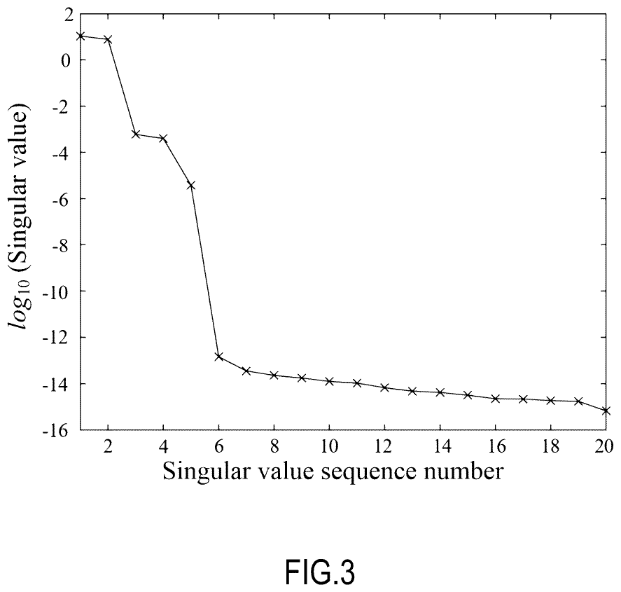

First 20 singular values on a diagonal of the singular value matrix Σ are drawn in FIG. 3. Due to a large difference in numerical values, logarithmic values are drawn after a base 10 is taken as a logarithm, sequence numbers are given according to positions in which the singular values are located in the matrix Σ, and the sequence number of the first singular value on the diagonal is given as 1, and so on. It may be seen through analysis of results obtained in FIG. 3 that the singular values having sequence numbers 6 to 20 are close in size. Left singular value vectors corresponding to the first k singular values are selected to construct a transformation matrix, the reduced-order model is constructed through the transformation matrix, and characteristic information U(k) of the transformation matrix without retaining original samples is calculated according to the following formula:

$$U ( k ) = {log}_{10} ( ( 1 - I ( k ) ) \times 100 \% ) \qquad ( 15 )$$

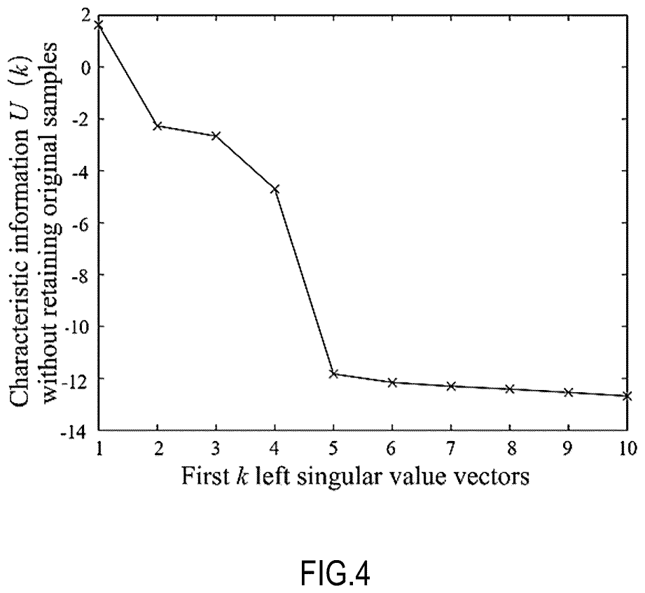

When k is less than 10, the characteristic information of the transformation matrix without retaining the original samples is shown in FIG. 4. It may be seen from FIG. 4 that when a value of k is greater than or equal to 5, the characteristic information of the transformation matrix without retaining the original samples is changed slightly. It may be seen through calculation that when the reduced order is 5, the transformation matrix does not retain 0.0001% of the characteristic information of the original samples, and therefore it is preliminarily determined that the reduced order is 5.

First five columns of a left singular value vector matrix W are selected to construct a transformation matrix Φ₅, the order of the finite element model is reduced through the transformation matrix to obtain a 5-order reduced-order model, formula (5) is substituted into formula (13), and two ends of formula (13) are multiplied left by Φ^{T}₅ to obtain the following formula:

$${Φ}_{5}^{T} {K}_{aa} {Φ}_{5} b = {Φ}_{5}^{T} ( {g}_{a} - {K}_{ab} {q}_{b} ) \qquad ( 16 )$$

b is a coefficient vector, and the length is the reduced order. A displacement vector may be reconstructed according to formula (5).

Under the same displacement boundary condition, the displacement solution of the joint is obtained by calculating the reduced-order model and the finite element model separately, and a relative error of each degree of freedom in the displacement solution of the joint of the reduced-order model is calculated. Since numerical values of most of relative errors are close, in order to clearly express the relative errors of the reduced-order model, relative error logarithmic values are used. The definition is as follows:

$${err}_{i} = {log}_{10} ( \vert \frac{{q}_{i} - {q}_{i ( 5 )}}{{q}_{i}} \vert ) \qquad ( 17 )$$

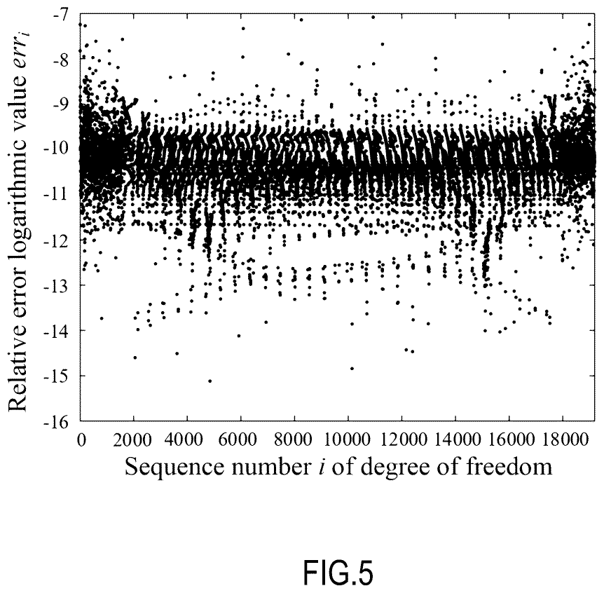

errᵢ is a relative error logarithmic value of the reduced-order model on an i-th degree of freedom; and qᵢ is a displacement value corresponding to the i-th degree of freedom in the displacement solution of the joint calculated by the finite element model, and qᵢ₍₅₎ is a displacement value corresponding to the i-th degree of freedom in the displacement solution of the joint calculated by the 5-order reduced-order model. All degrees of freedom in the displacement solution of the joint are calculated, and calculation results are drawn in FIG. 5. It may be seen from FIG. 5 that the relative error logarithmic value is concentrated around −10, and a maximum relative error logarithmic value does not exceed −7. It may be seen through calculation that a maximum relative error is 0.82×10⁻⁷, which satisfies the requirements of practical engineering application. Therefore, the reduced order of the tower is determined as a 5 order.

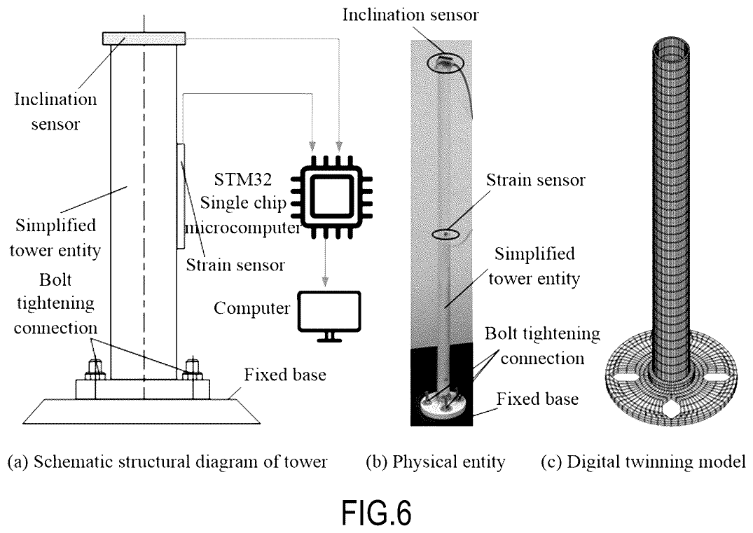

Step 3: a schematic structural diagram of the tower is shown in (a) of FIG. 6. A total length of the physical entity is 1 m. An inclination sensor WT61C is installed at the top end of the tower, and may detect an inclination angle of the end surface of the top end of the tower; a strain sensor BF350-3EB is installed at a position 0.5 m away from the ground on a tower body, and may measure an average strain at an installation position of the tower and output a voltage; and the data of the strain sensor and the inclination sensor is collected through the STM32 single chip microcomputer, the collected data is uploaded to the computer through a serial communication port of the single chip microcomputer, and the computer processes the data and calculates the stress and the strain of the tower. The finally established physical entity of the tower is shown in (b) of FIG. 6, and a digital twinning model is shown in (c) of FIG. 6.

An inclination angle of an end surface of a top end of the tower is detected through an inclination sensor, and the displacement boundary condition is obtained by combining formula (1) with formula (2); and a voltage value of a strain sensor is sampled and read through an analog-to-digital converter (ADC), and an average strain of the physical entity at an installation position of the strain sensor may be calculated according to formula (18).

$${e}_{0} = \frac{E}{4} ( \frac{Δ {R}_{1}}{{R}_{1}} + \frac{Δ {R}_{3}}{{R}_{3}} - \frac{Δ {R}_{2}}{{R}_{2}} - \frac{Δ {R}_{4}}{{R}_{4}} ) = E {K}_{s} ε \qquad ( 18 )$$

e₀ is an output voltage of the strain sensor, and has a unit of V; E is a supply voltage of the strain sensor, and has a unit of V; R₁, R₂, R₃ and R₄ are bridge resistors of the strain sensor, and have a unit of Ω; Kₛ is a sensitivity coefficient of the strain sensor, which is related to a material used by the strain sensor, and the sensitivity coefficient of the BF350-3EB strain sensor is 2.1; and ε is an average strain of the physical entity at the installation position of the strain sensor.

A von-mises stress at the joint may be calculated through six stress components at the unit joint on the basis of the following formula:

$${σ}_{von - mises} = \frac{\sqrt{2}}{2} \text{} \sqrt{{( {σ}_{xx} - {σ}_{yy} )}^{2} + {( {σ}_{yy} - {σ}_{𝓏𝓏} )}^{2} + {( {σ}_{𝓏𝓏} - {σ}_{xx} )}^{2} + 6 ( {σ}_{xy}^{2} + {σ}_{y 𝓏}^{2} + {σ}_{𝓏 x}^{2} )} \qquad ( 19 )$$

σₓₓ, σ_{yy}, σ_{zz}, σ_{xy}, σ_{yz} and σ_{zx} are six stress components of the stress at the unit joint separately, related definitions of which have been given in formula (14).

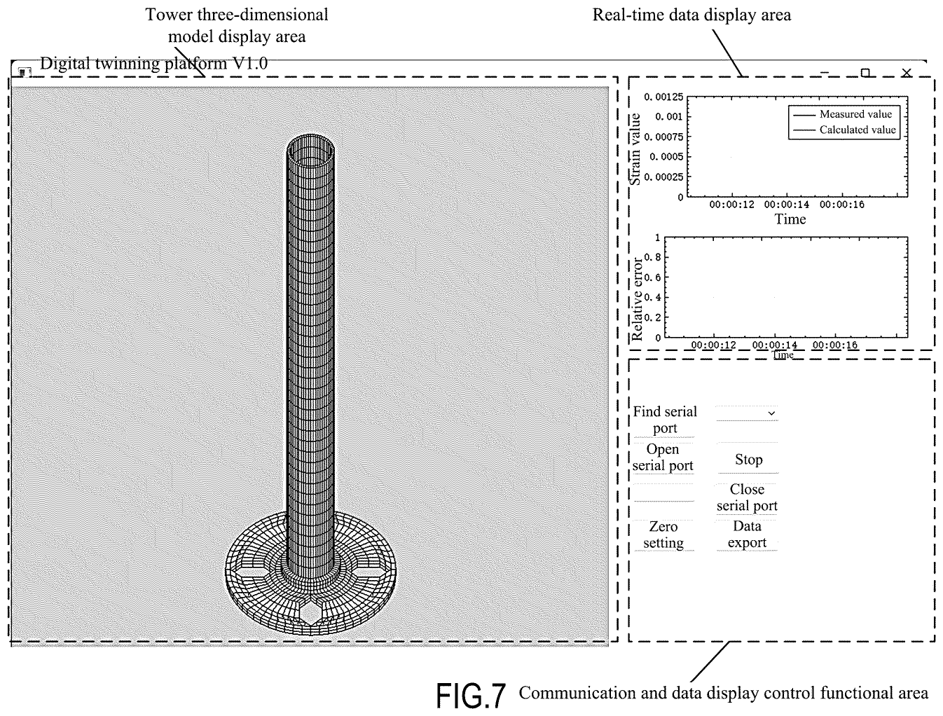

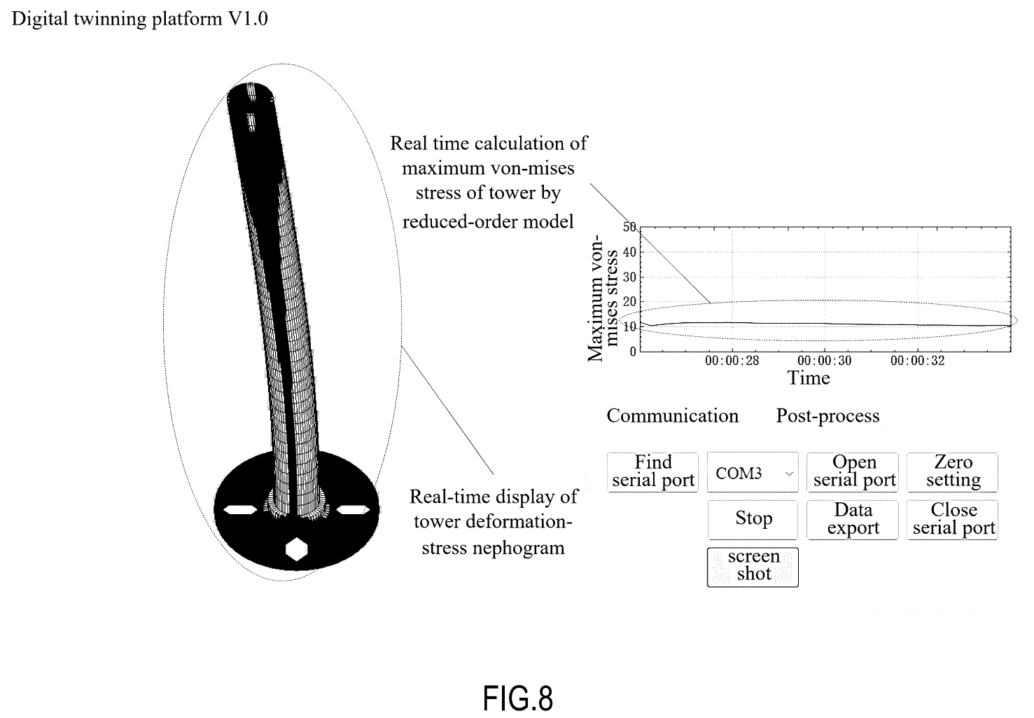

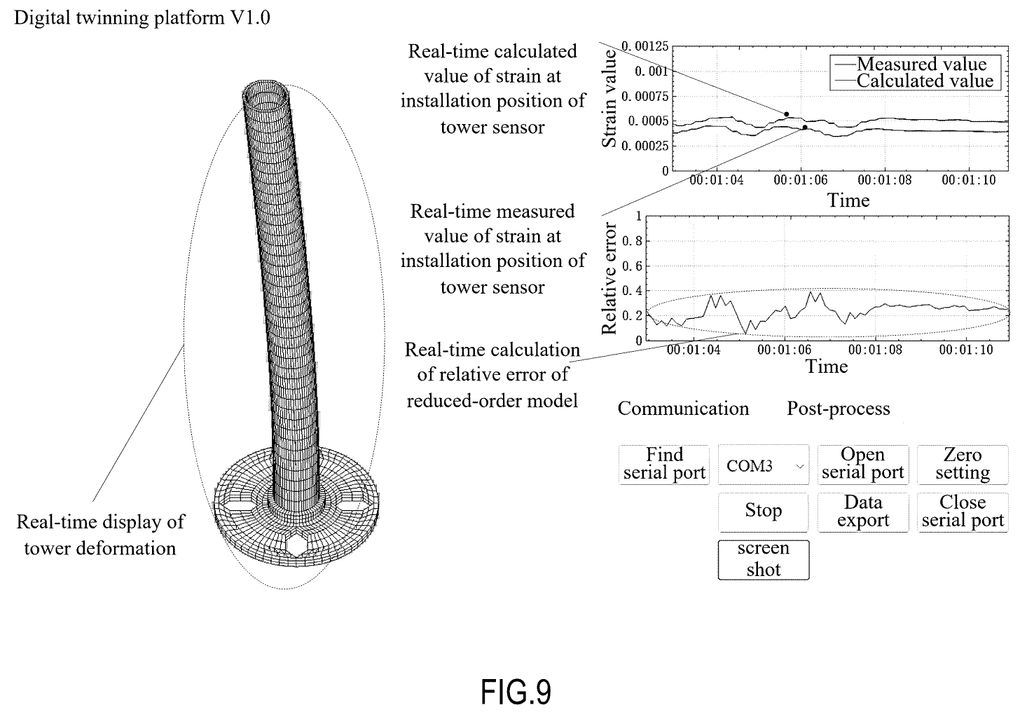

When the physical entity of the tower and the reduced-order model on the computer are interactively analyzed, the data of the inclination sensor and the strain sensor is read through an STM32 single chip microcomputer; the data is obtained, and then the data is uploaded to the computer through the STM32 single chip microcomputer; inclination data is processed and converted into the displacement boundary condition in the upper computer software that has been compiled, the displacement boundary condition is substituted into the 5-order reduced-order model that has been deployed in the upper computer to obtain the displacement solution of the joint, an interface of the upper computer software is shown in FIG. 7, and the interface is divided into three blocks, i.e. a tower three-dimensional model display area, a real-time data display area, and a communication and data display control function area; the von-mises stress at each joint is calculated through the displacement solution of the joint, results are drawn in the tower three-dimensional model display area through three-dimensional nephogram, a maximum joint von-mises stress value is displayed in real time in the data display area, and results are shown in FIG. 8; an average strain of the physical entity of the tower at the installation position of the strain sensor is calculated through the displacement solution of the joint, a deformed tower model is drawn in the three-dimensional model display area of the tower through the displacement solution of the joint, a measured value of the strain sensor uploaded by the STM32 single chip microcomputer and a calculated value of the reduced-order model are drawn in the same data visualization control in the real-time data display area, and moreover, a relative error of the reduced-order model is calculated, the relative error is displayed in another data visualization control in the real-time data display area, and strain online monitoring results of the simplified tower are shown in FIG. 9.

It may be seen from FIG. 8 that a maximum von-mises stress curve is changed gently and data does not have discontinuity and jump, which conforms to physical reality; and it may be seen from FIG. 9 that although a certain error exists between a calculated strain value of the reduced-order model and a measured strain value of the strain sensor, a change rule of the calculated strain value is consistent with a change rule of the measured strain value.

The present disclosure has the beneficial effects as follows:
the present disclosure provides the digital twinning method for monitoring an operation state of a tower of a wind turbine generator system online. Compared with the prior art, the method can rapidly obtain the current state of the tower of the wind turbine generator system and visualize the current state of the tower of the wind turbine generator system in a manner of stress nephogram and a strain curve, and an analysis result has high precision, thereby achieving the purpose of monitoring the operation state of the tower online.

To sum up, the digital twinning method based on the POD can effectively monitor the operation state of the tower of the wind turbine generator system online.

What is claimed is:

1. A digital twinning method for monitoring an operation state of a tower of a wind turbine generator system online, comprising:
step 1, obtaining a simplified physical model of the tower of the wind turbine generator system according to geometrical characteristics of the tower of the wind turbine generator system, and analyzing an actual stress condition of the tower to construct a finite element model of the tower;
step 2, carrying out order reduction analysis on the finite element model constructed in step 1 according to proper orthogonal decomposition (POD), comparing precision of a reduced-order model under different orders, and determining a final reduced order, wherein the final reduced order satisfies engineering requirements of the reduced model under the order; and
step 3, designing and constructing upper computer software in a computer, and deploying the reduced-order model of the tower to the upper computer software; building a physical entity of the tower, installing a strain sensor and an inclination sensor, reading sensor data and uploading the data to an upper computer through a single chip microcomputer, so as to convert the data into a displacement boundary condition, and then inputting the displacement boundary condition into the reduced-order model for calculation; and determining accuracy of the digital twinning method for monitoring the operation state of the tower by calculating an error between a measured strain value of the strain sensor and a calculated strain value of the reduced-order model in the upper computer.

2. The digital twinning method for monitoring an operation state of a tower of a wind turbine generator system online according to claim 1, wherein
the step 1 further comprises: simplifying a flange connection structure between the tower of the wind turbine generator system, and simplifying the tower into a beam structure, so as to construct the simplified physical model of the tower;
a point of intersection of an axis of the tower before bending deformation and a lower end surface of the tower is an origin O of a coordinate system XYZ; and normal vectors of an end surface at a top end of the tower before bending deformation and after bending deformation are n₀ and n₁ respectively, and an included angle between the two vectors is an inclination angle θ of the end surface at the top end of the tower, and an expression of deflection w and the inclination angle θ of the end surface at the top end of the tower is as follows:
$$\{ \begin{matrix}w = \frac{F}{6 EI} {L}^{3} - \frac{FL}{2 EI} {L}^{2} \\ θ = \frac{F}{2 EI} {L}^{2} - \frac{FL}{EI} L\end{matrix} ⇒ w = \frac{2}{3} L θ \qquad ( 1 )$$
wherein F is a concentrated load applied at the top end of the tower, and has a unit of N; E is an elastic modulus of a tower material, and has a unit of Pa; I is cross sectional moment of inertia of the tower, and has a unit of m⁴; and L is a length of the tower, and has a unit of m;
the deflection w and an azimuth φ need to be determined to describe the bending deformation of the tower in a three-dimensional space, wherein the azimuth φ is configured to express a bending orientation of the tower; and therefore, the displacement boundary condition of the finite element model of the tower is determined by the two parameters of w and φ, and according to a principle of linear superposition and decomposition of force, the displacement boundary condition of the tower is determined to obtain:
$${q}_{b} = {w}_{x} {q}_{bx} + {w}_{y} {q}_{by} = ( w cos φ ) {q}_{bx} + ( w sin φ ) {q}_{by} \qquad ( 2 )$$
wherein q_{bx}=[1, 0, 1, 0, . . . , 1, 0]^{T}, q_{by}=[0, 1, 0, 1, . . . , 0, 1]^{T}, and a vector length is determined by a specific displacement boundary condition; q_{b} is a joint displacement vector determined by the displacement boundary condition of the tower, i.e. a joint displacement vector corresponding to a joint having a displacement constraint of the tower; wₓ is a component of total deflection in a direction X; and w_{y} is a component of the total deflection in a direction Y; and
the deflection w at the top end of the tower is converted into the displacement boundary condition, the finite element model of the tower is constructed, and an equilibrium equation of the finite element model of the tower under the displacement boundary condition is shown in formula (3):
$$[ \begin{matrix}{K}_{a a} & {K}_{a b} \\ {K}_{b a} & {K}_{b b}\end{matrix} ] [ \begin{matrix}{q}_{a} \\ {q}_{b}\end{matrix} ] = [ \begin{matrix}{g}_{a} \\ {g}_{b}\end{matrix} ] + [ \begin{matrix}0 \\ {R}_{r}\end{matrix} ] \qquad ( 3 )$$
wherein Kₐₐ is a stiffness matrix corresponding to a joint node having no displacement constraint of the tower; K_{ab} and K_{ba} are coupling matrices between the joint having the displacement constraint and the node having no displacement constraint of the tower; K_{bb} is a stiffness matrix corresponding to the joint having the displacement constraint of the tower; qₐ is a joint displacement vector of the joint having no displacement constraint of the tower; gₐ and g_{b} are joint gravity load vectors corresponding to the joint having no displacement constraint and the joint having the displacement constraint of the tower respectively; and Rᵣ is a joint support reaction force vector corresponding to the joint having the displacement constraint of the tower.

3. The digital twinning method for monitoring an operation state of a tower of a wind turbine generator system online according to claim 1, wherein
the step 2 further comprises: constructing the reduced-order model of a displacement field of the tower by combining the POD with a finite element method as follows:
solving the finite element model of step 1 to obtain a displacement solution set of a joint, and selecting m samples from the set to form a matrix X=[q₁, q₂, . . . , qₘ], wherein qᵢ=[u₁, u₂, . . . , u_{z}]^{T} is a displacement solution of the joint, and z is the number of degrees of freedom of the finite element model; {ζ₁, ζ₂, . . . , ζₙ} is set as a group of n orthonormal bases of X, and is written as a matrix form denoted as Φ; and for the finite element model of the tower, a joint displacement value qₜ at any moment is represented by {ζ₁, ζ₂, . . . , ζₙ}:
$${q}_{t} = {\sum }_{i - 1}^{n} {b}_{ti} {ζ}_{i} \qquad ( 4 )$$
wherein bₜᵢ=ζᵢ^{T}qₜ;
selecting first k orthonormal basis vectors from {ζ₁, ζ₂, . . . , ζₙ} to represent qₜ:
$${q}_{t ( k )} = {\sum }_{i = 1}^{k} {b}_{ti} {ζ}_{i} = {Φ}_{k} {b}_{t ( k )} \qquad ( 5 )$$
wherein Φₖ=[ζ₁, ζ₂, . . . , ζₖ]; k<n; and bₜ₍ₖ₎=[bₜ₁, bₜ₁, . . . , bₜₖ]^{T};
establishing an error function as follows:
$${ε}^{2} = {\sum }_{t = 1}^{n} {‖ {q}_{t} - {q}_{t ( k )} ‖}_{2}^{2} = {\sum }_{j = k + 1}^{n} {ζ}_{j}^{T} {XX}^{T} {ζ}_{j} \qquad ( 6 )$$
in order to obtain an optimal solution of the error function under a constraint condition {ζ₁, ζ₂, . . . , ζₙ} of the orthogonal bases, introducing Lagrange factors uᵢⱼ (i, j=k+1, k+2, . . . , n) to construct a Lagrange function, so as to find the orthonormal bases corresponding to the optimal solution:
$$L = {\sum }_{j = k + 1}^{n} {ζ}_{j}^{T} {XX}^{T} {ζ}_{j} - {\sum }_{i = k + 1}^{n} {\sum }_{j = k + 1}^{n} [ {u}_{ij} ( {ζ}_{i}^{T} {ζ}_{j} - {δ}_{ij} ) ] \qquad ( 7 )$$
wherein δᵢⱼ is a Kronecker function;
solving a partial derivative of ζⱼ from two ends of formula (7) to obtain:
$$\frac{\partial L}{\partial {ζ}_{j}} = 2 ( {XX}^{T} {ζ}_{j} - {\sum }_{i = k + 1}^{n} {u}_{ij} {ζ}_{j} ) = 2 {XX}^{T} {ζ}_{j} - 2 {Φ}_{n - k} {u}_{j} \qquad ( 8 )$$
Φₙ₋ₖ=[ζₖ₊₁, ζₖ₊₂, . . . , ζₙ]^{T}, and uⱼ=[u_{k+1,j}, u_{k+2,j}, . . . , u_{n,j}]^{T};
writing the formula into a matrix form to obtain the following formula:
$$\frac{\partial L}{\partial {Φ}_{n - k}} = 2 ( {XX}^{T} {Φ}_{n - k} - {Φ}_{n - k} {U}_{n - k} ) \qquad ( 9 )$$
wherein Uₙ₋ₖ=[uₖ₊₁, uₖ₊₂, . . . , uₙ]^{T};
in order to solve the optimal solution, making equation (9) equal to 0, and multiplying the equation left by Φₙ₋ₖ^{T}, wherein internal vectors of a matrix Φₙ are orthonormal, and therefore Uₙ₋ₖ=Φₙ₋ₖ^{T}XX^{T}Φₙ₋ₖ=(X^{T}Φₙ₋ₖ)^{T}X^{T}Φₙ₋ₖ is obtained, and it is easy to know that Uₙ₋ₖ is a positive semi-definite matrix, and therefore an orthogonal matrix P exists to diagonalize Uₙ₋ₖ, so as to obtain P^{T}Φₙ₋ₖ^{T}XX^{T}Φₙ₋ₖP=P^{T}Uₙ₋ₖP=Λ; and multiply two ends of the formula left by Φₙ₋ₖP to obtain the following formula:
$$\begin{matrix}{Φ}_{n - k} {PP}^{T} {Φ}_{n - k}^{T} {XX}^{T} {Φ}_{n - k} P = {Φ}_{n - k} {PP}^{T} {U}_{n - k} P = {Φ}_{n - k} P Λ \\ ⇓\end{matrix} \qquad ( 10 )$$
$${XX}^{T} {Φ}_{n - k} P = {Φ}_{n - k} {U}_{n - k} P = {Φ}_{n - k} P Λ$$
wherein Λ is a diagonal matrix of Uₙ₋ₖ;
arranging diagonal elements of Λ in descending order, wherein it is seen from formula (10) that an i-th diagonal element of Λ is an eigenvalue λᵢ of XX^{T}, and an i-th column of a matrix Φₙ₋ₖP is an eigenvector of XX^{T} corresponding to λᵢ; and
considering that the orthogonal matrix is norm-preserving under a Frobenius norm ∥•∥_{F}², formula (6) is rewritten as:
$${ε}^{2} = {‖ {X}^{T} {Φ}_{n - k} ‖}_{F}^{2} = {‖ {X}^{T} {Φ}_{n - k} P ‖}_{F}^{2} = trace \{ {( {X}^{T} {Φ}_{n - k} P )}^{T} {X}^{T} {Φ}_{n - k} P \} = trace \{ Λ \} \qquad ( 11 )$$
forming a transformation matrix Φₙ from left singular value vectors corresponding to first n singular values of X, wherein Φₙ is an optimal solution of the error function under the condition that the constraint condition {ζ₁, ζ₂, . . . , ζₙ} is the orthonormal bases, and a minimum value of the error function is the sum of last n-k eigenvalues of the matrix XX^{T};
defining the following formula: ,
$$I ( k ) = {\sum }_{i = 1}^{k} {λ}_{i} / {\sum }_{i = 1}^{n} {λ}_{i} \qquad ( 12 )$$
wherein λᵢ is an eigenvalue of XX^{T} arranged in descending order; and
retaining, by a k-dimensional base vector, d % of characteristic information of an original sample under the condition of I(k)≥d %; and constructing the reduced-order model under different orders, and calculating precision of the reduced-order model under different reduced orders separately to determine the appropriate reduced order and obtain the reduced-order model, wherein the finally determined reduced order satisfies actual engineering requirements of the reduced-order model under the order.

4. The digital twinning method for monitoring an operation state of a tower of a wind turbine generator system online according to claim 1, wherein
in the step 3, the upper computer reads the sensor data uploaded by the single chip microcomputer, converts the data into the displacement boundary condition, and inputs the displacement boundary condition into the reduced-order model to achieve rapid calculation, so as to obtain calculated strain and stress values of the current physical entity of the tower and a displacement solution of a joint; after calculation of the reduced-order model is completed, a calculation result is processed in the upper computer, that is, deformation of the physical entity of the tower is rapidly quantified on the basis of the displacement solution of the joint and displayed in the upper computer; an error between a strain calculation result of the reduced-order model and an actual strain of the physical entity is obtained by means of a strain value calculated by the reduced-order model and a strain value measured by a sensor; and stress nephogram is visualized by combining the displacement solution of the joint with the calculated stress value to intuitively and clearly express stress distribution of the physical entity of the tower.
